(19) United States
(12) Patent Application Publication
(10) Pub. No.: US 2007/0041138 A1
(43) Pub. Date: Feb. 22, 2007

(54) Process and device for current limiting with an automatic current limiter

(75) Inventors: Kaveh Niayesh, Teheren (IR); Friedrich Konig, Oberbozberg (CH)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 10/564,037

(22) PCT Filed: Jul. 1, 2004
(86) PCT No.: PCT/CH04/00417

§ 371 Date: Jun. 21, 2006

(30) Foreign Application Priority Data
Jul. 10, 2003 (EP) 03405519.4

(51) Int. Cl. H02H 3/08

(52) U.S. Cl. 361/93.1

(57) ABSTRACT

The invention relates to a process and a device (1) for combined current limiting and circuit breaking and to a switchgear assembly with such a device (1). In a combined current limiter-circuit breaker (1) as claimed in the invention, a movable electrode (3, 3′) on the one hand for current limitation is guided automatically along one resistance element (5) for the current limitation path (31) by an overcurrent-dependent electromagnetic force (F_{mag}) and on the other hand for circuit breaking is moved into a series arrangement with an insulator (8). Embodiments include the following, among others: Use of the Lorenz force for automatic current limiting; movable electrode (3, 3′) implemented by liquid metal (3) or movable solid-state conductor (3′); an electrical resistance (Rₓ) which increases nonlinearly in the direction of motion (x) for a gentle current limiting characteristic; and a resistance element (5) in the form of a dielectric matrix (5) with several channels (3a) for the liquid metal (3). Advantages are among others: arc-free, reversible current limitation and current interruption, also suited for high voltages and currents, fast reaction times, low wear, and ease of maintenance.

### TECHNICAL DOMAIN

The invention relates to the area of primary engineering for electrical switchgear assemblies, especially limiting of fault currents in high, medium or low voltage switchgear assemblies. It is based on a process and a device for current limiting and a switchgear assembly with such a device as claimed in the preamble of the independent claims.

### PRIOR ART

DE 40 12 385 A1 discloses a current-controlled interrupting device with an operating principle which is based on the pinch effect with liquid metal. There is an individual, narrow, liquid metal-filled channel between the two solid metal electrodes. In an overcurrent, as a result of electromagnetic force the liquid conductor is constricted by the pinch effect so that the current itself pinches and separates the liquid conductor. The displaced liquid metal is collected in a storage tank and after the overcurrent event flows back again. Contact separation takes place without an arc. But the device is only suited for relatively small currents, low voltages and slow interruption times, and therefore does not offer a lasting off state.

DE 26 52 506 discloses an electrical high current switch with liquid metal. On the one hand, a liquid metal mixture is used for wetting the solid metal electrodes and for reducing the contact resistance. Here the liquid metal is driven into the contact gap against the force of gravity by mechanical displacement, for example by movable contacts or pneumatically driven plunger pistons. The liquid metal can be additionally stabilized and fixed in the contact gap by the pinch effect according to which a current-carrying conductor undergoes radial striction by the current which is flowing through it. External magnetic fields and magnetic stray fluxes, for example by current feeds, can cause flow instabilities in the liquid metal and are shielded and are optionally allowed during disconnection in order to support extinguishing of the arc in the liquid metal. The disadvantage is that gradual current limitation is not possible and arcs between the solid electrodes cause oxidation in the liquid metal. The design of the high current switch comprises seals for liquid metal, inert gas or a vacuum, and is accordingly complex.

DE 199 03 939 A1 discloses a self-recovering current limiting means with liquid metal. There is a pressure-proof insulating housing between the two solid metal electrodes; in it there is liquid metal in the compressor spaces and in the connecting channels which lie in between and which connect the compressor spaces, so that there is a current path for nominal currents between the solid electrodes. In the connecting channels the current path is narrowed relative to the compressor spaces. The connecting channels are greatly heated during short circuit currents and evolve a gas. Avalanche-like gas bubble formation in the connecting channels vaporizes the liquid metal into the compressor spaces so that a current limiting arc is ignited in the connecting channels from which liquid metal has now been removed. After decay of the overcurrent the liquid metal can condense again and the current path is again ready for operation.

WO 00/77811 discloses a development of the self-recovering current limiting means. The connecting channels are conically widened to the top, so that the fill level of the liquid metal can be varied and the rated current-carrying capacity can be changed over a wide range. Moreover, a meandering current path is formed by an offset arrangement of the connecting channels, so that in overcurrent-induced vaporization of the liquid metal a series of current-limiting arcs is ignited. These pinch effect current limiters require a structure which is very stable with respect to pressure and temperature; this is structurally complex. Major wear within the current limiters occurs due to current limiting by arc and burn-off residues can contaminate the liquid metal. Recondensation of the liquid metal causes a conductive state again immediately after a short circuit so that there is no off state.

GB 1 206 786 discloses a liquid metal-based electrical high current switch. The liquid metal in the first position forms a first current path for the operating current, is routed along a resistance element in current switching, and is moved into a second position in which it is in series with the resistance element and reduces the current to a small fraction. The high current switch is designed for producing high-intensity current pulses in the mega-ampere and submillisecond range for plasma generation.

U.S. Pat. No. 4,599,671 discloses a device for automatic current limitation as claimed in the preamble of the independent claims. A movable electrode is implemented in the form of a carriage which can move on rails and which can be electromagnetically deflected by short circuit currents. In the deflected state the carriage makes contact with a rail area which has a current-limiting electrical resistance for the current path. Instead of movable carriages, a liquid metal column which can be easily moved in a channel can be used as movable electrode. The current limiter does not in turn have an off state, but is located in series to a circuit breaker in order to first limit and then completely interrupt the current.

### DESCRIPTION OF THE INVENTION

The object of this invention is to devise a process, a device and an electrical switchgear assembly with such a device for improved and simplified current limiting and current interruption. This object is achieved as claimed in the invention by the features of the independent claims.

In a first aspect, the invention consists in a process for current limiting with a current limiting device which comprises stationary electrodes and at least one movable electrode, in the first operating state between the stationary electrodes an operating current being routed on a first current path through the current limiting device and the first current path being routed at least partially through the movable electrode which is in the first position, in a second operating state at least one movable electrode being moved automatically by an electromagnetic interaction with the overcurrent which is to be limited along one direction of motion into at least one second position, the movable electrode in a transition from the first position to the second position being guided along one resistance element and in at least one second position being in series with the resistance element and thus a current-limiting second current path being formed by the current limiting device which has a definable electrical resistance, furthermore in the third operating state the movable electrode being in series with the insulator and thus an insulating clearance for circuit breaking by the device being formed. As claimed in the invention, therefore an especially simple configuration for an automatic current-limiting switch or current limiter with an integrated switch is given. The overcurrent itself triggers current limitation. The underlying electromagnetic interaction is for example the Lorenz force on a current carrying conductor in a magnetic field, but also a capacitive, inductive, electrostatic or in some other way electromagnetic action of the overcurrent on the movable conductor section or the movable electrode are conceivable. Since the movable electrode makes contact with the electrical resistance, not the insulator, in the current limitation case, an arc is not ignited. Therefore the current limiting process can also be used at very high voltage levels. Moreover hardly any wear by burnoff or by corrosion of the movable electrode occurs. Current limitation takes place reversibly and is therefore maintenance-friendly and economical.

In a first embodiment, the third operating state is triggered by an interruption command by which an external magnetic field is switched over between operation of the device as a current limiter and as a circuit breaker.

In another embodiment, in the third operating state the movable electrode is moved along the opposite direction of motion into at least one third position and in at least one third position is in series with the insulator.

In another embodiment, the movable electrode is automatically guided along the resistance element to an extreme second position by the electromagnetic interaction with the overcurrent which is to be limited, the extreme second position lying in the area in which the resistance element passes into an insulator, so that an insulating clearance or another insulating clearance for current interruption is formed.

In another embodiment, the resistance element for achieving a gentle interruption characteristic with an electrical resistance which rises nonlinearly along the direction of motion of the movable electrode for the second current path is chosen; and/or the resistance element is ohmic and the electrical resistance increases continuously with the second position. In this way a gentle current limitation characteristic for progressive current limitation is implemented.

The embodiment as claimed in claim 6 has the advantage that the magnetic field acts directly on the current-carrying movable electrode and sets it into motion by the Lorenz force. The Lorenz force is proportional to the product of the magnetic field strength and the current. The magnetic field can be produced externally, especially constantly or in a switchable manner, or internally, especially by the current which is to be limited. By balancing the Lorenz force and a suitable resetting force the resulting motion can be adapted to the overcurrent to be limited and to the electrode deflection which is necessary for the required electrical resistance.

Claim 7 specifies dimensioning criteria for optimum design of the dynamics of the current limitation process.

Claims 8 and 9 give advantageous embodiments with a liquid metal and/or a sliding contact-solid state conductor as the movable electrode. In particular, high voltages and high currents can be efficiently and reliably managed by a series connection of liquid metal columns in alternation with a dielectric.

In another aspect the invention relates to a device for current limitation, especially for executing the process, encompassing stationary electrodes and at least one movable electrode, there being a first current path for an operating current through the current limiting device in the first operating state between the stationary electrodes, and the first current path leading at least partially through the movable electrode which is located in the first position, electromagnetic drive means being present for movement of the movable electrode along one direction of motion into at least one second position, which movement is automatic in an overcurrent, electrical resistance means with a definable electrical resistance being present and in the second operating state the movable electrode being at least partially in series with the resistance means and together with them forming a second current path on which the operating current can be limited to the current which is to be limited, in the third operating state the movable electrode being in series with the insulator and thus an insulating clearance for power interruption by the device being present

Other embodiments, advantages and applications of the invention follow from the dependent claims and from the description and figures below.

### BRIEF DESCRIPTION OF THE DRAWINGS

FIGS. 1a, 1b show a current limiting means which is automatic as claimed in the invention with liquid metal for rated current operation and in the current limitation case;

FIGS. 2, 3 show two current limiting means which are automatic as claimed in the invention with a mechanical sliding contact in rated current operation (broken-line) and in the current limitation case;

FIG. 4 shows a current-limiting switch with a capture mechanism for liquid metal in rated current operation;

FIG. 5 shows the curve of the variation of the resistance of the current limiter as a function of the position of the liquid metal column; and

FIG. 6 shows a combined liquid metal current limiter and liquid metal circuit breaker with an external magnetic field drive for the liquid metal.

In the figures the same parts are provided with the same reference numbers.

### EMBODIMENTS OF THE INVENTION

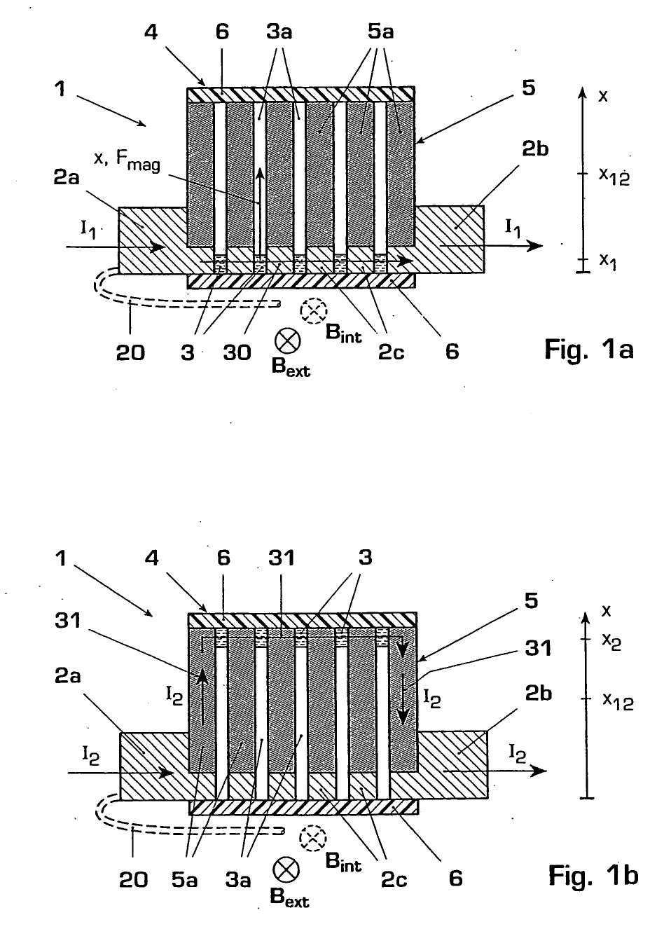

FIGS. 1a, 1b show one embodiment of the liquid metal current limiter 1. The current limiter 1 comprises solid metal electrodes 2a and 2b and intermediate electrodes 2c for current supply 20 and a tank 4 for the liquid metal 3. The tank 4 has a bottom 6 and a top 6 of insulator material between which there is an electrical resistance means 5 with at least one channel 3a for the liquid metal 3. A protective gas, an insulating liquid (with an alternate volume which is not shown here) or a vacuum can be located over the liquid metal column 3.

As claimed in the invention, the liquid metal 3 or in general a movable electrode 3, 3′ is set into motion by an automatic electromagnetic interaction with the overcurrent I₂ which is to be limited. In the case of a liquid metal 3, it remains in the liquid aggregate state and is moved by forced motion selectively between the different positions x₁, x₁₂ or x₂. The pinch effect is not used here. Very fast current limitation reaction times of down to less than 1 ms can be achieved. Moreover, in addition to the rated current path 30 and the current limitation path 31 there is an insulating clearance 32.

Preferably the second operating state is automatically activated by the overcurrent I₂ by the currently-carrying movable electrode 3, 3′ being moved by the electromagnetic force F_{mag} which is perpendicular to the current 12 through the movable electrode 3, 3′ and perpendicular to the magnetic field Bₑₓₜ, Bᵢₙₜ, and which has one force component parallel to the direction of motion x, 1, the magnetic field Bₑₓₜ, Bᵢₙₜ being chosen as an external magnetic field Bₑₓₜ and/or as an internal magnetic field Bᵢₙₜ which is produced by a current feed 2a, 2b; 20 to the current limiting device 1. Alternatively to the Lorenz force, another automatic electromagnetic interaction with the overcurrent 12 can also be used for current limitation, for example a capacitive, inductive, electrostatic or some other type of interaction. Here automatic means that the motion of the movable electrode is triggered and controlled without active current measurement and without active control engineering.

In the first operating state (FIG. 1a) an operating or rated current I₁ flows on the first or rated current path 30 from the input electrode 2a via the liquid metal 3 and optionally the intermediate electrodes 2c to the outgoing electrode 2b. The liquid metal 3 is in the first position x₁ here, wets at least in part the stationary electrodes 2a, 2b, 2c and bridges the channels 3a in an electrically conductive manner. In the second operating state (FIG. 1b) the liquid metal 3 is moved along the direction of motion x given by the vertical extension of the channels 3a into a second position x₂, is in series there with the electrical resistance means 5 and with it forms a second current path or current limitation path 31 for the current I₂ which is to be limited. For an especially compact arrangement, the rated current path 30 and the current-limiting second current path 31 are parallel to one another and the two are perpendicular to the vertical extension of the channels 3a at a variable height which can be given by the second position x₁₂, x₂ of the liquid metal 3.

Preferably the resistance means 5 comprises a dielectric matrix 5 which has wall-like segments 5a for dielectric separation of a plurality of channels 3a for the liquid metal 3, the segments 5a having a dielectric material with a resistance Rₓ which increases in the direction of motion x, preferably nonlinearly. The segments 5a thus represent individual resistances 5a of the resistance element 5 with an electrical resistance Rₓ which increases along the channel height, preferably nonlinearly. At the height of the first position x, of the liquid metal 3, the segments 5a should have intermediate electrodes 2c for electrically conductive connection of the channels 3a. The channels 3a are preferably located essentially parallel to one another. Thus, the current-limiting second current path 31 is formed by an alternative series connection of channel areas 3a which are filled with liquid metal 3 and the segments 5a which act as individual resistances 5a of the resistance element 5 which are progressive with length, and preferably nonlinearly progressive.

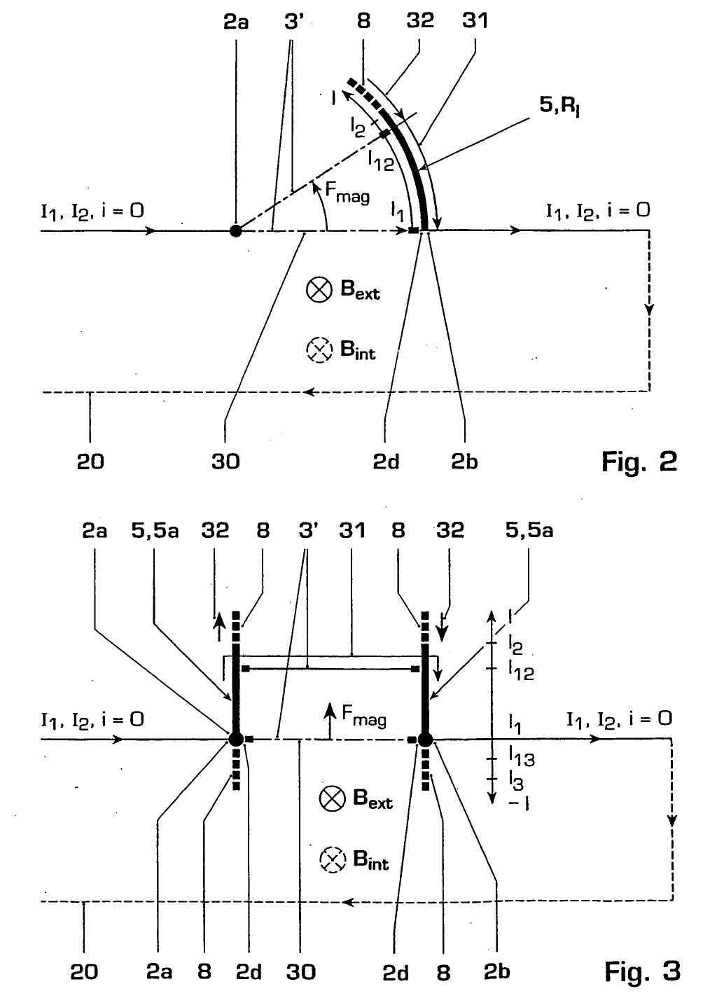

FIGS. 2 and 3 show embodiments in which the movable electrode 3, 3′ comprises a solid-state conductor 3′ with at least one sliding contact 2d and in the first operating state with the stationary electrodes 2a, 2b in the second operating state is electrically connected at least on one side to the resistance element 5 and in the third operating state at least on one side it is connected to the insulator 8. Advantageously the solid-state conductor 3′ is made essentially of lightweight metal and/or in a lightweight construction, for example from metal-coated cork and/or the sliding contact 2d is wetted with liquid metal for reducing friction. FIG. 2 shows one embodiment in which the solid-state conductor 3′ is connected on one end with a pivoting capacity to the input electrode 2a and on the other end can be moved with the sliding contact with a sliding capacity along an arc-shaped resistance element 5. FIG. 3 shows one embodiment in which the solid-state conductor 3, 3′ has sliding contacts 2d on the two ends and between wall-like resistances 5a of the resistance means 5 can be raised like a balancing beam over its entire length by electromagnetic interaction against a resetting force Fᵣ, especially against the force of gravity. The path positions 1₁, 1₁₂, 1₂ of the sliding contact 2d correspond to the aforementioned second positions x₁, x₁₂, x₂ of the liquid metal column 3. The extreme second position 1₁₂ can be located in the area in which the resistance means 5 passes into an insulator 8, so that an insulating clearance 32 is present for current interruption.

In a transition from the first position x₁, 1₁ to the second position x₁₂, x₂, 1₁₂, 1₂, especially to the extreme second position x₂, 1₂, the liquid metal 3 or the solid-state conductor 3′ with a sliding contact 2d is guided along the resistance element 5. To achieve a gentle current limitation or interruption characteristic, the resistance element 5 has an electrical resistance Rₓ, R₁ which rises nonlinearly along the direction of motion x₁, 1₁ of the movable electrode 3, 3′ for the second current path 31. The resistance element 5 should have an ohmic portion and is preferably purely ohmic with an electrical resistance Rₓ, R₁ which rises continuously with the second position x₁₂, x₂, 1₁₂, 1₂. For arc-free switching of the current i(t) from the stationary electrodes 2a, 2b, 2c to the resistance element 5, a typical minimum arc ignition voltage of 10 V-20 V which is dependent on the contact material should not be exceeded.

Two current limiters 1 with triggering of electrode motion which is active in phase opposition can be connected in series in order to achieve current limitation and optionally current interruption in each current half wave.

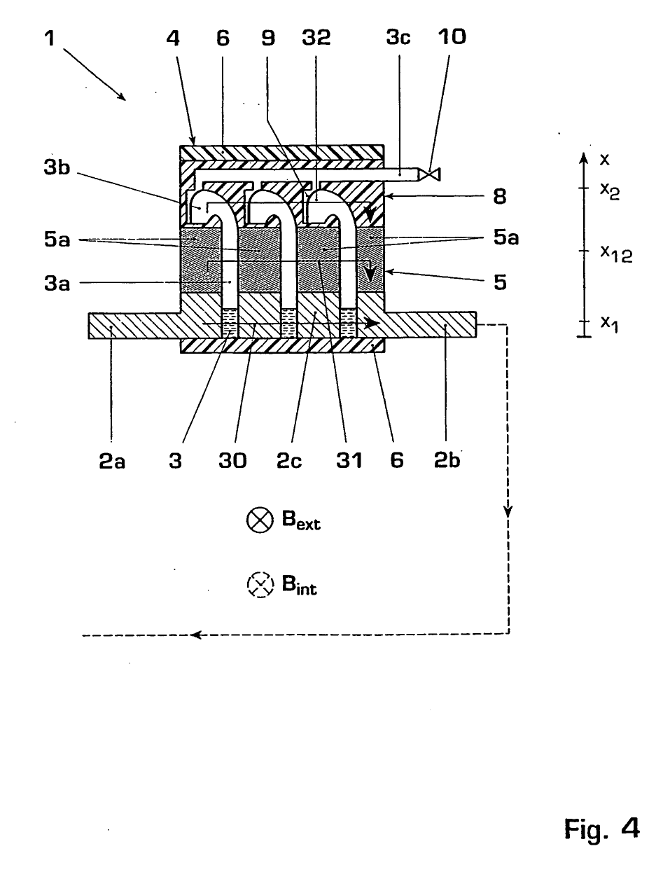

FIG. 4 shows one version of the current limiter 1 in which a capture tank 3b for holding the liquid metal 3 and for forming insulating clearance 32 for current interruption is present. Moreover, as shown, there can be a supply 3c for the liquid metal 3 for filling the channels 3a with liquid metal 3 and for reconnection of the device 1. Moreover, in addition to the rated current path 30 and to the current limiting path 31, there is insulating clearance 32 on which the segments 5a for current limitation pass into segments 8a for current insulation. The insulation segments 8a consist essentially of insulation material, are preferably located in the area of the capture vessel 3c and together with the channels which have been emptied of the captured liquid metal 3 form the insulating clearance 32. Here therefore the liquid metal 3 can be moved between the rated current path 30, the current limiting path 31 and the insulating clearance 32 for current interruption, so that an integrated, liquid metal-based current-limiting switch 1 is implemented. Advantageously the first current path 30 for the operating current I₁ the second current path 31 for current limitation, and the insulating clearance 32 are essentially perpendicular to the direction of motion x and/or essentially parallel to one another. This yields an especially simple configuration for an integrated current limiter-circuit breaker 1 which works exclusively with liquid metal 3.

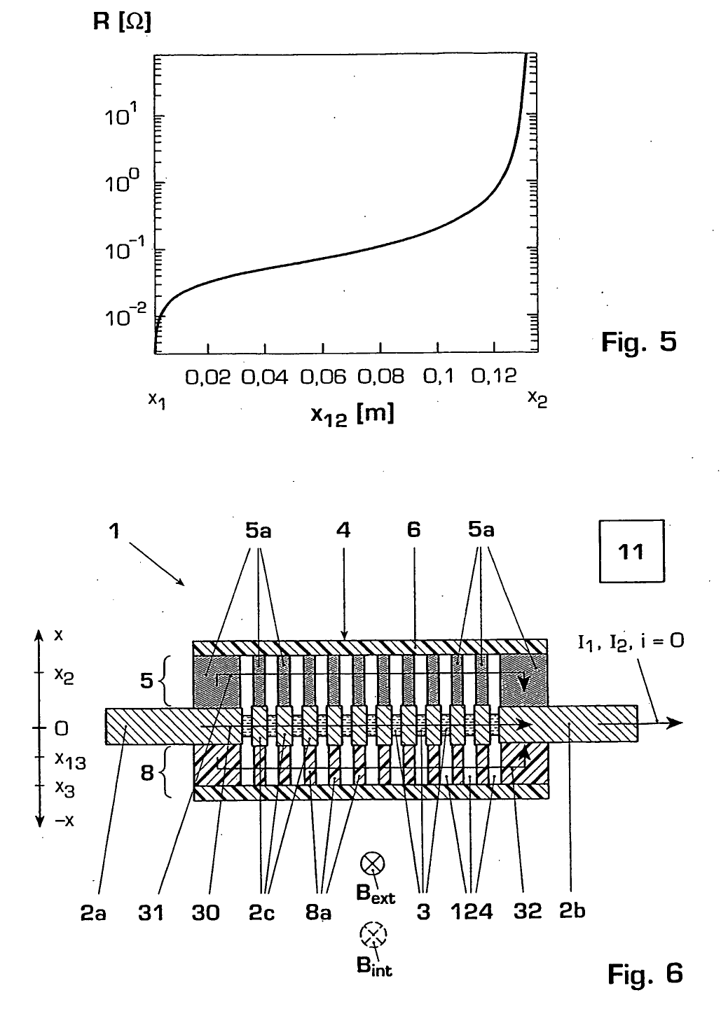

FIG. 5 for the current limiting switch 1 shows the dimensioning of the electrical resistance Rₓ, R₁ as a function of the second position x₁₂, 1₁₂ of the movable electrode 3, 3′. Advantageously the resistance Rₓ, R₁ up to an extreme second position x₂, 1₂ is chosen to rise nonlinearly to a maximum value Rₓ (x₂), R₁ (1₂). For a given voltage level the maximum value Rₓ (x₂), R₁ (1₂) of the electrical resistance Rₓ, R₁ should also be dimensioned to a finite value according to the current I₂ to be limited or to a dielectric insulation value for interrupting the operating current I₁.

The electrical resistance Rₓ, R₁ as a function Rₓ(x₁₂), R₁(1₁₂) of the second position x₁₂, 1₁₂ and a path-time characteristic x₁₂(t), 1₁₂(t) of the movable electrode 3, 3′ along the direction of motion x, 1 should be chosen such that in every other position x₁₂, x₂, 1₁₂, 1₂ of the movable electrode 3, 3′ the product of the electrical resistance Rₓ, R₁ and the current I₂ is less than the arc ignition voltage U_{b} between the movable electrode 3, 3′ and the stationary electrodes 2a, 2b and optionally the intermediate electrodes 2c and/or that sufficient steepness of current limitation for controlling line-induced short circuit currents i(t) is achieved.

In all the aforementioned embodiments the electromagnetic drive means 2a, 2b, 20; 11; Bᵢₙₜ, Bₑₓₜ comprise magnetic field means 2a, 2b, 20; 11 for producing the magnetic field Bₑₓₜ, Bᵢₙₜ which exerts a Lorenz force F_{mag} with a force component parallel to the direction of motion x, 1 on the movable electrode 3, 3′ through which the current I₁, I₂ has flowed, so that the movable electrode 3, 3′ can be moved between the first current path 30 for the operating current I₁, the second current path 31 for current limitation, and the insulating clearance 32 for current interruption. The magnetic field means 2a, 2b, 20; 11 can comprise the current supply 2a, 2b; 20 to the current limiting device 1 in order to produce an internal magnetic field Bᵢₙₜ which is dependent on the overcurrent I₂ which is to be limited. Moreover, the magnetic field means 2a, 2b, 20; 11 can comprise means 11 for producing an external controllable and especially reversible magnetic field Bₑₓₜ.

The dimensioning of the liquid metal current limiter 1 is discussed by way of example in conjunction with FIG. 5. To control the short circuits a current limiting resistance Rₓ is necessary which is dependent on the current line parameters and the breakdown behavior of the contacts 2a, 2b which are to be separated. The greater the steepness of the short circuit current i(t), the lower must Rₓ be selected to be. In the least favorable case the maximum short circuit current amplitude and the maximum short circuit current inductance must be assumed. Then the following applies:
Rₓ(t)·i(t)<U_{b}(t) (G1)
Rₓ(t)·i(t)+L·di/dt(t)=U_{N}(t) (G2)
where t=time variable, L=line inductance in the case of a short circuit, U_{N}=operating or line voltage, d/dt is equal to the first and d²/dt² is equal to the second time derivative. In equation (G2) it was assumed that the resistance in the line is Rₗᵢₙₑ<<L and the line voltage U_{N} is maintained during a short circuit. Furthermore the equation of motion (G3) applies to the liquid metal 3 with the mass m, the position or deflection x₁₂(t), the coefficient of friction a and the driving force F
m·d²x₁₂/dt²+α·dx₁₂/dt(t)=F−Fᵣ (G3)
Fᵣ=resetting force, especially Fᵣ=F_{g}+F_{cap} with F_{g}=m·g being equal to the force of gravity, where m=mass of the liquid metal 3 and g=acceleration of gravity, and F_{cap} being equal to the capillary force.

In FIG. 5 for example an electromagnetic Lorenz force F=F_{mag} which is exerted on the liquid metal 3 by self-interaction of the current i(t) which is to be limited was assumed. Then the following applies in addition
F=k·i²(t) (G4)
with k=geometry-dependent proportionality constant. For an external magnetic field B, F=k′·i(t) with k′=other proportionality constant, applies. In detail k and k′ depend on the geometry of the current limiter 1, especially the structure and arrangement of the resistance element 5 and the current paths 30, 31 and the insulating clearance 32, and on the arrangement of the magnetic field means 2a, 2b, 20.

In FIG. 5 the following were assumed by way of example: a short circuit-induced current steepness di/dt=15 kA/ms, U_{N}=1 kV, I₁=1 kA, maximum short circuit current I₂=50 kA and plausible parameter values for k, m and α. Then, by solving equations (G2)−(G4) under the boundary condition (G1), the resistance Rₓ(t) and the path-time characteristic x₁₂(t) of the liquid metal 3 arise and finally by elimination of the time dependency, the resistance Rₓ(x₁₂) as a function of the second position x₁₂, as shown logarithmically in FIG. 5, is found. Proceeding from the first position x₁, i.e. when the liquid metal 3 is detached from the solid electrodes 2a, 2b, 2c, Rₓ first increases overproportionally with the second position X₁₂, then rises linearly in the phase in which the energy stored in the line inductance L must be absorbed and then passes again into a steeper, i.e. overproportional rise Rₓ(x₁₂) in the area in which the current i is already limited and larger Rₓ become tolerable.

The total resistance of the current limiter 1 is determined in the first operating state at a nominal current I₁ by the liquid metal distances 3 and can accordingly be fixed at definable values by making available a suitable liquid metal cross section. The maximum resistance Rₓ(x₁₂) of the current limiter 1 can be dimensioned by the choice of the resistance material 5 and by its geometrical configuration according to the desired voltage level and maximally allowable overcurrent I₂.

In particular, a resistance Rₓ which rises nonlinearly with the path distance x can be implemented by materials with different resistivities. A nonlinearly rising total resistance Rₓ can also be implemented by suitable geometric routing of the current path in a resistance element with a homogeneous resistivity. Nonlinear graduation of the resistance Rₓ can also be achieved by a combination of the two measures, specifically by suitable geometric current routing in a resistance element with variable resistivity.

The threshold current Iₜₕ, starting from which the current limiting device 1 is activated, arises when the electromagnetic drive force E_{mag} exceeds the resetting force Fᵣ. In the embodiments as shown in FIGS. 1a, 1b, 4 and 6 the resetting force Fᵣ=F_{g}+F_{cap}. Iₜₕ can be estimated from it to be
Iₜₕ=[(F_{g}+F_{cap})/k]^{1/2}. (G6)
In the simplified case in which the capillary forces F_{cap} are negligible and the magnetic field is produced by a coil geometry the following applies
Iₜₕ=[(A·g·d·p)/(μ·N)]^{1/2} (G7)
where A=cross sectional area of the liquid metal channels 3a, ρ=mass density of the liquid metal 3, d=length of the magnetic field-generating coil in the current supply 2a, 2b, 20, μ=magnetic permeability in the coil or in the liquid metal and N=number of turns of the coil. The reaction time tᵤ up to complete current limiting, i.e. until reaching the end position as shown in FIG. 1b (or also FIG. 2 or FIG. 3), can be dimensioned by suitable dimensioning of the magnetic field means 2a, 2b, 20, 11 and the resetting forces F_{g}, F_{cap} to definable values.

FIG. 1b shows the position of the liquid metal 3 in the current limitation case. Based on the current limitation which takes effect, the electromagnetic force F_{mag} on the liquid metal 3 decreases and the liquid metal 3 flows under the action of the force of gravity F_{g} back again into the initial position between the electrodes 2a, 2b, 2c. The reclosing time t_{d} can be estimated to be the following under the assumption that the capillary force F_{cap} and the electromagnetic force F_{mag} for a limited current i are negligible
t_{d}=[(2·h)/g]^{1/2}, (G8)
in which h=x₂−x₁=height of the liquid metal channels 3a.

The reclosing time t_{d} can be adapted to the requirements of different applications by a suitable design of the current limiter 1. In particular, the quantities which influence the channel height h and the capillary forces F_{cap} such as the channel cross sectional area A, the channel geometry and the surface composition of the channels, as well as the type of liquid metal 3, must be chosen accordingly.

In the thermal design of the current limiter 1 it must be watched that due to the short reaction times and also reconnection times the resistance element 5 cannot be effectively cooled. The dissipated energy Eₗₒₛₛ heats the current limiter 1. The temperature rise ΔT is approximately
ΔT=Eₗₒₛₛ/(A·l·ρ′·c′). (G9)
where A=cross sectional area of the liquid metal parts (as before), l=total length of the current limiter 1 or of the resistance element 5, ρ′=average mass density of the current limiter 1 and c′=average thermal capacity of the current limiter 1. The energy loss Eₗₒₛₛ in this case of resistive current limitation is much smaller than for current limitation by arc. One important advantage of the distributed or matrix-like resistance element 5 consists also in that the power loss Eₗₒₛₛ occurs largely uniformly distributed over the volume of the current limiter 1 and accordingly the entire thermal mass or heat capacity for absorption of the energy loss Eₗₒₛₛ can be exhausted.

FIG. 6 shows a combined liquid metal current limiter 1 and liquid metal circuit breaker 1 with electromagnetic drive means 2a, 2b, 20; 11; Bᵢₙₜ, Bₑₓₜ for the liquid metal 3. The magnetic field Bᵢₙₜ can be produced internally by the feeding or draining current conductor 20 and/or preferably by an external magnetic field source Bₑₓₜ which can be reversed with respect to its magnetic field direction. When the liquid metal 3 is moved in the positive direction of motion +x, the current i is routed on the current limitation path 31 and limited as discussed above. Alternatively the liquid metal 3 in a third operating state can be moved along the opposite direction of motion −x into at least one third position x₁₃, x₃, the liquid metal 3 in at least one third position x₁₃, x₃ being in series with an insulator 8 and thus an insulating clearance 32 for circuit breaking by the device 1 being formed. As shown, the insulating clearance 8 can be formed by a plurality of insulating segments 8a which in the case of interruption are in an alternating series connection with the liquid metal columns 3 which have been moved down. FIG. 3 shows by the broken line the analogous case for negative deflections 1 and positions 1₁₃, 1₃ of a movably suspended solid-state conductor 3′. In particular, the third operating state is triggered by an interruption command by which an external magnetic field Bₑₓₜ is reversed between the operation of the device 1 as a current limiter and as a circuit breaker. Suitable liquid metals 3 are for example mercury, gallium, cesium, and GaInSn.

Advantageously at least the insulating clearance 32 for current interruption is located above the second current path 31 and/or underneath the first current path 30. In this way a compact arrangement of the liquid metal 3 and its drive mechanism 12 relative to the currents which are to be switched, especially to the rated current path 30, the current limiting path 31 and the current interruption path 32, is implemented. The current limiter 1 in FIG. 6 can also be designed as a current-limiting switch 1, as described above.

Applications of the device 1 relate among others to use as a current limiter, current-limiting switch and/or circuit breaker 1 in power supply grids, as a self-recovering fuse or as an engine starter. The invention also comprises an electrical switchgear assembly, especially a high or medium voltage switchgear assembly, characterized by the device 1 as described above.

### REFERENCE NUMBER LIST

1 liquid metal current limiter
2a, 2b solid metal electrodes, metal plates, stationary electrodes
2c intermediate electrodes
2d mechanical sliding contact with path-dependent resistance
20 current supply, current conductor
3 liquid metal
3a channels for liquid metal
3b capture tank for liquid metal
3c supply for liquid metal
30 current path for operating current, first current path
31 current path for current limiting, second current path
32 current interruption path, insulating clearance
4 liquid metal tank
5 resistance element for current limiting, resistance matrix for liquid metal
5a individual resistances
6 tank cover, housing wall, insulator
8 insulator for current interruption
8a individual insulators
9 flexible membrane
10 valve for liquid metal supply
11 magnetic field control
124 back-pressure vessel, captured gas volume
α coefficient of friction
Bₑₓₜ, Bᵢₙₜ external, internal magnetic field
F_{mag} magnetic force
Fᵣ resetting force
i current
Iᵢ operating current
I₂ limited overcurrent
k proportionality constant
1, 1₁, 1₂, 1₁₂, 1₃, 1₁₃ sliding contact positions
L line inductance
P₁, P₂, P₃ gas pressure
Rₓ, R₁ resistance of the current limiter
t time variable
U_{b} arc ignition voltage
U_{N} line voltage, operating voltage
V₁, V₂, V₃ gas volume
x, x₁, x₂, x₁₂, x₃, x₁₃ positions of the liquid metal column

1-16. (canceled)

17. Process for current limiting and/or circuit breaking with a liquid metal current switch which comprises solid electrodes and a liquid metal tank with at least one channel for a liquid metal, in the first operating state between the solid electrodes an operating current being routed on a first current path through the current switch and the first current path being routed at least partially through the liquid metal which is in the first position, wherein in a second operating state
a) the liquid metal is moved by a dielectric fluid drive which is controlled by a control along one direction of motion into at least one second position, a dielectric working fluid being used which acts mechanically directly with a definable drive pressure on one surface of the liquid metal, and
b) the liquid metal in at least one second position is located at least partially in series with the dielectric and in this way a current-limiting and/or current-interrupting second current path is formed by the current switch, and
c) for a given voltage level a maximum electrical resistance of the dielectric being dimensioned to a finite value according to the current which is to be limited or to a dielectric insulation value for interrupting the current.

18. Process as claimed in claim 17, wherein
a) the working fluid is a dielectric gas and/or a dielectric liquid and the working fluid is essentially not mixed with the liquid metal and
b) especially wherein the working fluid is an insulating gas, especially dry air, nitrogen, sulfur hexafluoride, argon or a vacuum, and/or an insulator liquid, especially transformer oil or silicone oil.

19. Process as claimed in claim 17, wherein
a) the drive pressure is chosen to be slightly lower than the surface tension of the surface of the liquid metal which is exposed to pressure and/or
b) the liquid metal in the first and in the second operating state remains in the liquid aggregate state.

20. Process as claimed in claim 17, wherein
a) the dielectric is a resistance element with a definable electrical resistance,
b) the liquid metal in a transition from the first position to the second position, especially to an extreme second position is guided along the resistance element and
c) the resistance element has an electrical resistance which increases along the direction of motion of the liquid metal for the second current path.

21. Process as claimed in claim 17, wherein in the third operating state
a) the liquid metal is moved along the opposite direction of motion into at least one third position and
b) the liquid metal in at least one third position is in series with an insulator and thus an insulating clearance for circuit breaking by the device is formed and
c) especially wherein the third operating state is triggered by an interruption command by which the fluid drive is switched over between operation of the current switch as the current limiter and as a circuit breaker.

22. Process as claimed in claim 17, wherein the dielectric fluid drive is a pressure drive with pressure vessels, valves and a control for a working fluid by which a working pressure vessel for the working fluid for moving the liquid metal can be connected to an interruption pressure vessel for contact opening of the liquid metal and to a connection pressure vessel for contact-closing of the liquid metal.

23. Process as claimed in claim 17, wherein the dielectric fluid drive is a piezodrive with at least one piezoelectrically driven piston and the drive fluid is incompressible and with a pressure which can be dictated by the piston acts mechanically directly on the first surface of the liquid metal.

24. Process as claimed in claim 23, wherein
a) the liquid metal is carried over the first surface by the drive fluid and the liquid metal is moved for contact opening by the piezodrive such that a contact gap between the solid electrodes is filled with the drive fluid and/or
b) the area of the piston is greater than or equal to the piezoelectrically driven area of a piezoactuator of the piezodrive.

25. Liquid metal current switch for current limiting and/or circuit breaking, especially for executing the process as claimed in claim 17, comprising solid electrodes and a liquid metal tank with at least one channel for a liquid metal, in the first operating state between the solid electrodes there being a first current path for an operating current through the current switch and the first current path leading at least partially through the liquid metal which is in the first position, wherein
a) a dielectric fluid drive has a working fluid and a control and is designed for moving the liquid metal along one direction of motion into at least one second position, the working fluid being dielectric and acting mechanically directly with a definable drive pressure on one surface of the liquid metal, and
b) in the liquid metal tank there is a dielectric and
c) in the second operating state the liquid metal in at least one second position is at least partially in series with the dielectric and thus forms a current-limiting and/or current-interrupting second current path in the current switch,
d) for a given voltage level a maximum electrical resistance of the dielectric being dimensioned to a finite value according to the current which is to be limited or to a dielectric insulation value for interrupting the current.

26. Liquid metal current switch as claimed in claim 25, wherein
a) the drive pressure is rated according to the switching time of the current switch, especially according to the overcurrent which is to be limited, and a path-time characteristic of the liquid metal in the second current path which is necessary for this purpose, and/or
b) the drive pressure is chosen to be lower than the surface tension of the surface of the liquid metal which is exposed to pressure.

27. Liquid metal current switch as claimed in claim 25, wherein
a) the cross sectional area of the liquid metal in the first current path is dimensioned according to the current carrying capacity of the current switch and/or
b) the width and number of segments for separating the channels for the liquid metal and the type of working fluid are dimensioned according to the dielectric strength of the current switch in the second operating state; and/or
c) the cross section and the surface composition of the channels for the liquid metal and the type of liquid metal are dimensioned according to the required surface tension of the surface of the liquid metal which is exposed to pressure.

28. Liquid metal current switch as claimed in claim 25, wherein
a) the dielectric comprises a resistance means which for arc-free current limitation has an electrical resistance which increases continuously along the direction of motion up to an extreme second position for the second current path and/or
b) the dielectric comprises an insulator which is designed for current interruption, especially with arc formation.

29. Liquid metal current switch as claimed in claim 25, wherein
a) in the liquid metal tank there are several channels for the liquid metal which are essentially parallel to one another, which extended along the direction of motion x and which are separated by wall-like segments from one another and
b) the segments end in the area of the first current path in a common tank area for flow of the liquid metal together and for transmitting the operating current and the segments in the area of the second current path have individual resistances or individual insulators of the dielectric.

30. Liquid metal current switch as claimed in claim 25, wherein
a) the first path for the operating current, the second current path for current limitation and especially an insulating clearance for current interruption are arranged essentially perpendicular to the direction of motion and/or are arranged essentially parallel to one another, and/or
b) at least the insulating clearance for current interruption is located above the second current path and/or underneath the first current path.

31. Liquid metal current switch as claimed in claim 25, wherein
a) the fluid drive has first means for producing a drive pressure in the fluid and second means for bringing the working fluid into contact with the liquid metal,
b) especially wherein the first means comprise an interruption pressure vessel for contact opening of the liquid metal and a connection pressure vessel for contact closing of the liquid metal, and
c) especially wherein the second means comprise at least one valve and a working pressure vessel for transferring the pressure from the working fluid to the liquid metal and preferably a compression pressure vessel with a captured compressible fluid for applying a resetting force to the back surface of the liquid metal.

32. Liquid metal current switch as claimed in claim 25, wherein the fluid drive has a piezodrive with at least one piezoelectric piston for moving the liquid metal .

33. Liquid metal current switch as claimed in claim 32, wherein
a) the piezodrive has a piezoactuator which by this movable piston and a dielectric drive fluid for transmitting pressure from the piston to the liquid metal and/or
b) the piezodrive comprises a pressure vessel for collecting the drive fluid and a drive channel for supplying the drive fluid to at least one channel for the liquid metal.

34. Liquid metal current switch as claimed in claim 32, wherein
a) the drive fluid of the piezodrive is an insulator liquid which is incompressible and which cannot be mixed with the liquid metal and which is in direct pressure exchange with at least one pressure-exposed first surface of the liquid metal and/or
b) in the second operating state the liquid metal is displaced by the piezodrive out of the contact gaps and is replaced by the drive fluid and/or the insulating gas.

35. Electrical switchgear assembly, especially a high or medium voltage switchgear assembly, comprising a device as claimed in claim 25.
